(19) United States
(12) Patent Application Publication
(10) Pub. No.: US 2004/0203644 A1
(43) Pub. Date: Oct. 14, 2004

(54) Customized notification

(76) Inventors: Randal Alan Anders, Round Rock, TX (US); Carol Ann Dolan, Austin, TX (US); William Joel Hoch, Pflugerville, TX (US); Paul William Podipny, Austin, TX (US); Jeffrey Walter Richardson, Austin, TX (US); David Neal Rundell, Leander, TX (US)

Correspondence Address: MARILYN SMITH DAWKINS, INTELLECTUAL PROPERTY LAW DEPARTMENT, INTERNATIONAL BUSINESS MACHINES CORP., 11400 BURNET ROAD, AUSTIN, TX, 78758, US

(21) Appl. No.: 10/171,585

(22) Filed: Jun. 13, 2002

(51) Int. Cl. H04M 3/42

(52) U.S. Cl. 455/414.1; 455/567; 455/461

(57) ABSTRACT

Systems and methods for providing customized ring pattern, volume or other notification, of an incoming communication, or other occurrence, directed toward a personal communication device, such as a cellular phone, according to data included in a profile. The profile data can include a predetermined schedule of events and also include reference to a source of a communication. The schedule of an event can include a description of a location for the event. Notification, which is customized according to the profile, can be contingent upon physical presence at the specified location. Customization can include modifying, delaying or negating a notification of an incoming communication according the profile, which considers the source of the communication and a schedule set forth by a user.

### CROSS REFERENCE TO RELATED APPLICATION

This application cross references the application entitled “Cellular Communication Device Interaction with a Personal Information Manager” filed concurrently with this application, and bearing the Express Mail Number ______.

### BACKGROUND

The present invention relates generally to apparatus and methods for specifying a type of notification which can be implemented with a personal communications device. In particular, embodiments of the present invention relate to specifying a type of notification to be implemented on a personal communications device, such as a cellular phone, personal digital assistant (PDA) and the like, according to data input by a user and a user's location.

An increase in the use of personal communications devices (PCD) has presented new challenges for a user of such a device. The portable nature of a PCD allows for the PCD to be with a user at all times. Typically a signal, such as a ring or an alarm is utilized to beckon a user to the PCD in order to respond to an incoming call or message, or to alert a user that a scheduled appointment is imminent. A PCD may allow a user to choose from a variety of signals, including different tones or patterns of tones that will sound to signal an incoming message or announce an event. It is known for a tone to be simple patterns or emulate a melody.

Typically, a PCD signal is indiscriminate, and often sounds at inappropriate times, such as when engaged in a meeting or other event. Although it is known for a user to be able to silence a PCD, or to implement a vibrating notification, it is often inconvenient for the user to constantly modify a notification setting, such as a telephone ring, in response to circumstances as they arise. In addition, a user may want to receive one or more communications, such as an emergency communication or call from an important client, but not be interrupted by other communications.

However, it may be difficult for the user to determine who is attempting to contact them without the user responding to the PCD. In essence, a user can become tied to the responsibility of constantly attending to the PCD.

Therefore, it would be advantageous to provide a method and apparatus that overcame the drawbacks of the prior art. In particular, it would be desirable to provide methods and apparatus that allow a user to specify what rules will govern notification of an incoming communication or of a pending appointment and provide customized notification.

### SUMMARY

Accordingly, embodiments of the present invention include methods for setting a ring volume on a mobile telephone, or other PCD, by determining a current location of the PCD and automatically setting the ring volume according to a predetermined preference setting for a location type of the current location. The PCD can automatically be set to generate a notification, such as a ring, in response to an incoming communication, such as a voice call, received at a current location.

A current location can be determined utilizing an automated means, such as a global positioning satellite (GPS) signal, or manually entered. A set of preferences specifying location types with various ring volume settings can be received, as can a set of preferences specifying location types with various ring volume settings. In addition, a GPS determined location can be correlated with a location type.

Embodiments can also include a location at a given time being determined from a calendar entry associated with the given time, wherein the calendar entry is accessible to the determining means. The calendar entry can also be utilized to specify a ring volume for a given calendar event.

In another aspect, embodiments can include a system for facilitating a wireless communication with a means for receiving and storing data descriptive of a schedule event, wherein the data comprises a notification profile and a means for determining a geographic location, such as a GPS unit utilizing a GPS signal. The system can also include a mechanism for receiving an indication of an incoming communication and a mechanism for generating a notification according the received data and one or more of a) geographic location b) time c) date and d) party originating the communication.

An incoming communication can include, for example: a voice call, an alphanumeric text message, a page or other type of wireless communication. A notification that is generated can include, for example: a ring with an adjustment to one or more of a) ring volume b) ring tone and c) ring pattern; a vibration; a visual indication; or other type of stimulus or indicator. In addition, a profile can specify that any indication of notification be withheld for a given location, or location type.

In other aspects, the means for determining a geographic location can include data input by a user and the data descriptive of a schedule event can be received from a personal information manager.

Embodiments of the present invention can include methods, systems, apparatus, executable software, and data signals implementing the inventive concepts disclosed herein. The data signal can be operative with a computing device, and executable software can be embodied on a computer readable medium.

Various features and embodiments are further described in the following figures, description and claims.

### DESCRIPTION OF THE DRAWINGS

FIG. 1 illustrates a block diagram illustrating major components included in some embodiments of the present invention.

FIG. 2 illustrates components of a system that can be utilized while implementing some embodiments of the present invention.

FIG. 3 illustrates a flow of exemplary steps that can be executed while implementing some embodiments of the present invention.

FIG. 4 illustrates a flow of exemplary steps that can be executed to determine if notification should be generated according to a profile.

FIG. 5 illustrates an exemplary data structure that can be utilized in a database implementing some embodiments of the present invention.

FIG. 6 illustrates an exemplary GUI that can be utilized while implementing some embodiments of the present invention.

### DETAILED DESCRIPTION

Various embodiments of the present invention include apparatus and methods for providing customized notification of an incoming communication, or other occurrence, directed toward a PCD according to data included in a profile. The profile data can include a predetermined schedule of events and also include reference to a source of a communication. The schedule of an event can include a description of a location for the event. Notification, which is customized according to the profile, can be contingent upon physical presence at the specified location. Customization can include modifying, delaying or negating a notification of an incoming communication according the profile, which considers the source of the communication and a schedule set forth by a user.

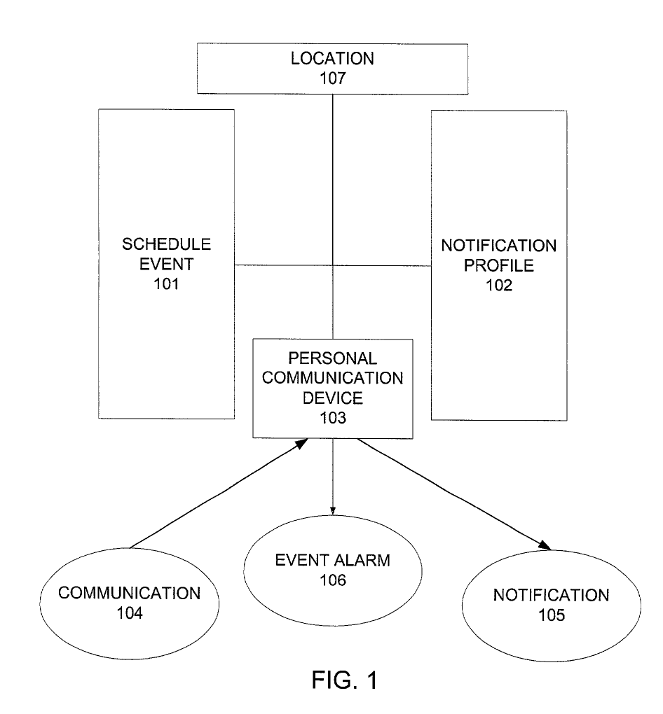

Referring now to FIG. 1, basic components that can be included in some embodiments of the present invention are illustrated. A PCD 103 can receive schedule events 101 input by a user. The schedule events 101 are typically entered into calendar function via a software program, such as a personal information manager (PIM) or other automated calendar. A schedule event 101 can include a location and duration for an event 101 entered. Additional information typically entered with a schedule event 101 can include people or entities involved and a purpose for the event 101. A location can include a geographic description of the location, such as a street address and/or a location type, such as an office, a conference hall, a place of worship, and the like.

A PCD 103 can include, for example, a cellular telephone, PDA, pager, or other device capable of being carried by a user and utilized to communicate with a person or automated facility. A PCD 103 can also include a device with any combination of features typically associated with one or another type of communication device, integrated into one device. An example of a PCD with integrated features can include, for example, a cellular phone with an electronic calendar or PIM capability.

An incoming communication 104 can include, for example: a telephone call; an e-mail message or other text message, including instant messaging and the like; a voice message; a page; or other type of communication. Other occurrences can include, for example, an alert signaling a pending appointment, or other scheduled event 101 recorded in the PCD 103.

A notification profile 102 can be associated with a schedule event 101 and contain information relating to one or more user preferences regarding how to receive a notification 105 of an incoming communication 104 or an event alarm 106. The notification profile 102 can contain general instructions, which can act as default notification 105 instructions. The notification profile 102 can also include details relating to providing a notification 105 during a specified time period associated with a schedule event 101. For example, if a schedule event 101 includes a meeting from 10:00 A.M. to 11:00 A.M. a user can specify instructions relating how to provide notification during the scheduled meeting time.

A notification 105 indicative of an incoming communication 104, or other occurrence, can be modified according to instructions set forth in the notification profile 102. The notification profile 102 can specify a modified notification 105 for a time period that correlates with a schedule event 101 and/or a default notification profile 102. Modification of notification 105 can include, for example: adjusting a ring tone; adjusting a ring pattern; adjusting a ring volume; silencing all ringing; providing a vibration indication; providing a visual indication; providing any combination of ringing, visual indicators and vibrating indication; including modified patterns or volumes; or withholding all indication of notification 105.

A modification to a notification 105 can also be made according to a party originating a communication 104. A notification profile 102 can specify that if a particular party should originate a communication 104, such as for example, a voice call, the PCD 103 can provide a particular notification 105 indicative of the party calling. The party originating a communication 104 can be determined, for example with Caller ID information, via an originating e-mail address or other means of identifying an originating party which is appropriate for a particular communication 104 type.

Embodiments can also include a notification 105 or modification of a notification 105 predicated upon a confirmation of a schedule event 101. Confirmation of the schedule event 101 can include a manual confirmation by a user that a user has arrived at a location 107 specified for the schedule event 101, automated confirmation based upon a current location 107, or other mechanism. Manual confirmation can be accomplished via a user interface, such as, for example, depressing some combination of user keys or buttons, or input into a graphical user interface (GUI).

Location 107 can also be automatically determined and compared with a location 107 specified for a schedule event 101, a notification profile 102, or other reference. A determination of a location 107 can be utilized as a verification of user participation in an event 101 and implement notification 105 according to a corresponding notification profile 102. Automated location determination can be accomplished via a location technology, such as, for example, a global positioning satellite (GPS) system, enhanced observed time difference/time of arrival (E-OTD/TOA), or triangulated LORAN-C.

A global positioning satellite system, as utilized with some embodiments, can include a constellation of satellites orbiting above the earth and continuously broadcasting information including an identity and location of the satellite via electromagnetic signals. Some embodiments can include determining a geographic location according to the satellite signals. The satellite signals can be encoded with the time they are transmitted from the satellite. By subtracting a time in the encoded transmission from a time of reception by a GPS receiver, a propagation time delay between transmission and reception of the signals can be determined. A relative position of the GPS receiver can then be derived according to the propagation time delay and a speed at which the electromagnetic waves travel through the atmosphere. Using geometry, such as triangulation, the location of a GPS receiver can be determined.

E-OTD/TOA can make use of a radio frequency (RF) transmission that is dedicated to location determination. The transmission can be made from multiple cell towers. The RF transmissions can be received by a PCD 103 and a mathematical calculation can utilize triangulation to calculate a location. A software only approach can be similar to E-OTD/TOA, but utilize existing signal strength instead of a transmission dedicated to location determination. The software only approach can utilize triangulation based upon signal strength received from multiple towers.

Still, another example of a mechanism that can be utilized to determine a geographic location includes use of a LORAN-C transmitting network to provide raw data, which can be used with a known triangulation computation technique. Generally speaking, a typical LORAN-C system can include a master transmitting station and four or more slave transmitters. The master station can transmit a coded series of pulses, which are utilized to synchronize the operation of the slave transmitters. After a predetermined coding delay, each slave transmitter can transmit coded pulses. LORAN-C receiver placed at a location receives both the signals transmitted by the master as well as the signal transmitted by slave transmitter. With known latitude and longitude coordinates for each station, time delays between the transmission by the slave transmitter and receipt of these signals by the receiver can be utilized with a standard triangulation technique to determine latitude and longitude coordinates.

Embodiments can include GPS, E-OTD/TOA, LORAN or other location determination electronics built into a PCD 103 and utilized to constantly or periodically calculate a location 107 of a user, or utilized to calculate a location responsive to a stimulus to provide notification 105, such as, for example, an incoming call, incoming e-mail or scheduled event 101 alert. A calculated location 107 can be associated with an address of a schedule event 101. For example, GPS coordinates can be translated into, or otherwise associated with, a street address. The street address can be entered into the schedule event 101, the notification profile 102 or other reference. If arrival at the street address is confirmed by the calculated location 107, the instructions contained in the notification profile 102 and relating to notification 105 can be implemented. If the calculated location 107 indicates that the user has not arrived at a location 107 specified for a schedule event 101, the notification profile 102 associated with the particular schedule event 101 can be overridden and a default notification profile 102, or other notification scheme, can be implemented.

Embodiments can also include an automated verification of location 107 at or about the time of a schedule event 101. If a calculated location 107 is determined to be the location of a schedule event 101 a notification profile 102 for the schedule event 101 can be implemented for the duration of time associated with the schedule event 101 and returned to a default notification profile 102 or transitioned to a new notification profile 102, if contiguous schedule events 101 are entered. Similarly, if a calculated location 107 changes, the change in calculated location 107 can be utilized to indicate that a particular schedule event 101 has been terminated and the system 100 can revert to a default notification profile 102 or other notification criteria.

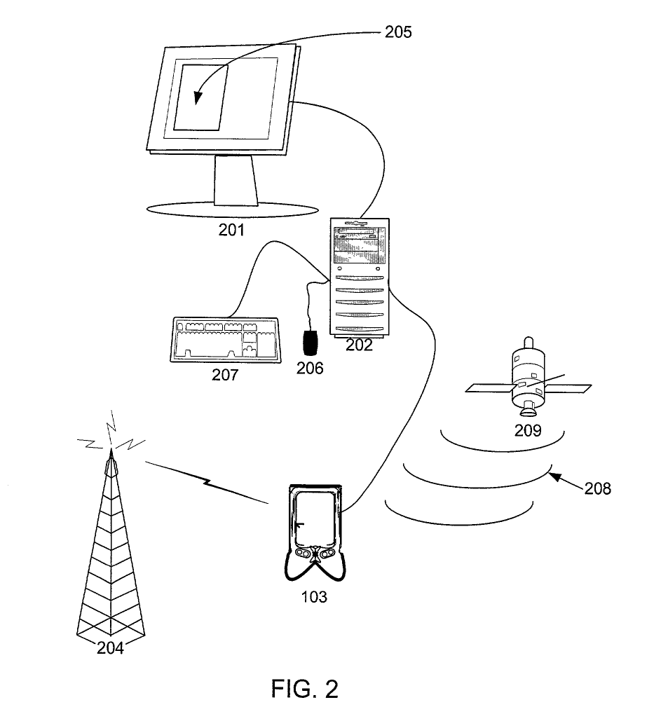

Referring now to FIG. 2, an exemplary system that can be utilized with some embodiments of the present invention is illustrated. The system can include a computing unit 202 containing a processor, memory and storage device, such as a disk drive. The computing unit 202 can be functionally connected to a display 201 and input devices, such as a keyboard 207, a mouse 206 or other input device. The computing unit can also be functionally connected to a PCD 103. Software operative with the computing unit 202 can be utilized to receive input from a user regarding a schedule event 101, as well as a notification profile 102 or details relating to an event alarm 106. Input can be received, for example, via a graphical user interface (GUI) 205 presented on a display 201 or on a PCD 103. Therefore, embodiments can also include input from a user being received into the PCD 103.

Still other embodiments can include information, such as a schedule event 101, notification profile 102, location information 107, event alarm 106 details or other information being generated by an automated means, such as via a software program running on the computing device or information received from an external source, such as, for example, an event scheduled by another party requesting the participation of the user for a schedule event 101.

The PCD 103 can also receive information relating to a location 107 via an automated means, such as, for example, a transmission 208 from a GPS system 209 or a LORAN transmission.

A communication 104 can be received at the PCD 103 via a wireless communications network 204, such as, a cellular phone network.

Software associated with a PCD 103 can include executable program code, or other software. In some cases, an executable program, such as a Java™ program, may be downloaded from a website available in the Internet and installed on the computing device 202 or the PCD 103. Other implementations include proprietary software installed from a computer readable medium, such as a CD ROM or DVD. Some embodiments may therefore be implemented in digital electronic circuitry, computer hardware, firmware, software, or in combinations of the above. Other embodiments may be implemented in a computer program product tangibly embodied in a machine-readable storage device for execution by a programmable processor; and method steps may be performed by a programmable processor executing a program of instructions to perform functions by operating on input data and generating output.

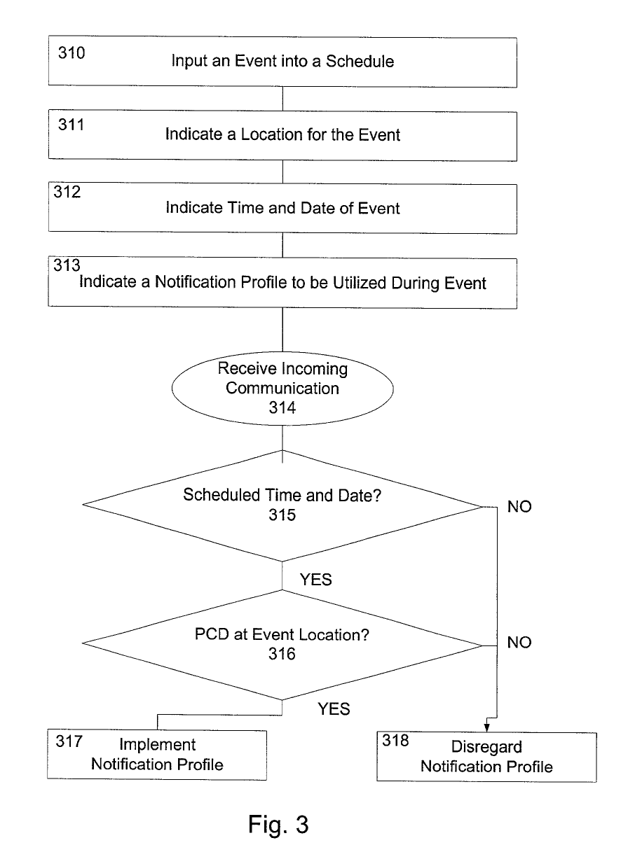

Referring now to FIG. 3, steps that can be executed to implement embodiments of the current invention can include inputting an event into a schedule, calendar or other vehicle for organizing or tracking events 310. A location associated with event can be indicated 311, as well as a time and date of an event 312. The event information, location, as well as time and date can be indicated, for example, by keying information descriptive of the event into a computing device 202 or by entering the information into the PCD 103. If desired, information entered into the PCD 103 and the computing device 202 can be synchronized by a link between the PCD 103 and the computing device 202.

A notification profile 102 which is to be utilized during an event can also be indicated 313, such as, for example, by inputting details relating to a notification profile 102 into a computing device 202 or into the PCD 103.

An incoming communication 104 to the PCD 103 can be received 314. An automated process, such as a process implemented by a software program, can determine if the time and date at which the communication is received correlates with a time and date entered 315 for an event 101. If the time and date that the communication is received does correlate with a time and date indicated for an event 101, a verification of the location 107 of the event can be made to determine if the PCD 103 is situated at the location 107 indicated 316 for the event 101.

An affirmative response to a determination of whether a calculated location 107 of a PCD 103 correlates with a location 107 specified for an event 101 can result in notification 105 according to the notification profile 102 being implemented 317.

If the time and date that a communication 104 is received does not correlate with a time and date for an event 101, or if a determined location 107 cannot be verified as the location specified for the event 101, then a notification profile 102 associated with an event 101 can be disregarded 318.

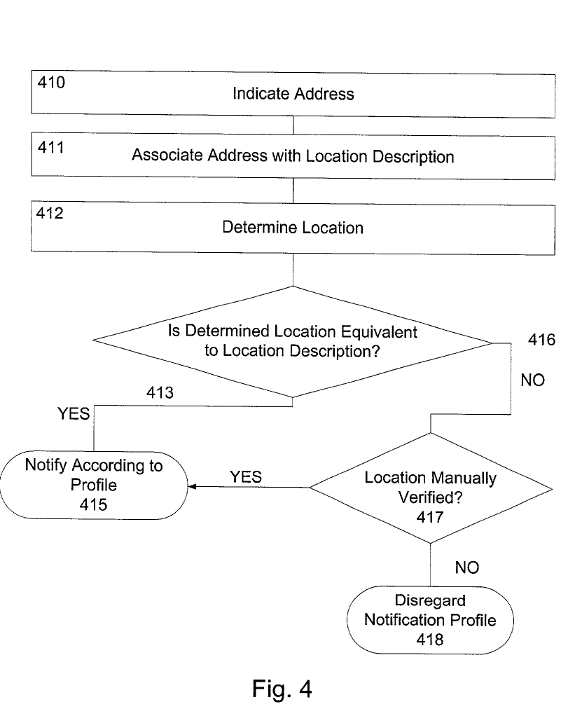

Referring now to FIG. 4, exemplary steps that can be taken to determine if a PCD 103 is at a location specified for an event 101 are illustrated. A street address associated with an event 101 can be indicated 410, for example, by entering the address into a computing device 202 or a PCD 103. The street address can be associated with a location description 411. A location description can include, for example, GPS coordinates, longitude and latitude coordinates, or other determination of a physical location.

As actual location of the PCD 103 can then be determined utilizing an electronic method correlating with the location description 412. If the determined location is equivalent to the location description 413, notification 105 can be accomplished according to an associated notification profile 415.

If a determined PCD 103 location 107 is not equivalent to the location 107 description for an event 416, a check can be made to determine if a location 107 has been manually verified 417. If the location has been manually verified, notification 105 can be accomplished 415 according to the notification profile 102 associated with the event 101. If the location 107 has not been manually verified 417 and the determined location 107 is not equivalent to the location 107 description, the notification profile 102 can be disregarded 418.

In some embodiments a location 107 description can include a location type. Therefore, associating an address with a location description 411 can also associate the address with a location type. A location type can be indicated for example by referencing a database of locations and corresponding location types. A location type correlating to a location in the database that is in the closest proximity to a determined location 107 can also be utilized as an indicated location type. Each location type can have a notification profile 102 associated with it. Notification, such as a ring volume, can be automatically set according to a predetermined preference for a particular location type thereby enabling a PCD 103 to automatically ring at a set ring volume, or provide other notification according to location type for a current location.

Embodiments can also include receiving a set of preferences specifying multiple location types and various associated ring volumes. As a PCD 102 is moved between locations 107, a corresponding location type can be determined such that a ring volume, or other notification 105, can be adjusted accordingly with various ring settings.

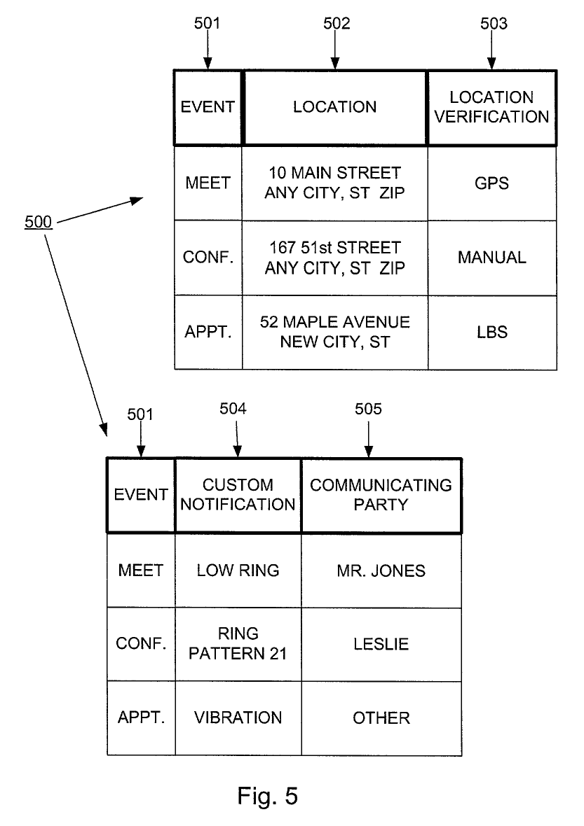

Referring now to FIG. 5, an exemplary data structure 500 is illustrated that can be utilized in a notification system. Data useful for implementing embodiments of the present invention can include data fields containing: an event description field 501; a location field 502; and a location verification field 503. Related data fields can be linked, for example, by the event data field 501. Related additional fields can include therefore, for example, a customized notification data field 504 with data representative of a specific notification which can be utilized during a schedule event 501 if a communication is received from a specified communicating party 505.

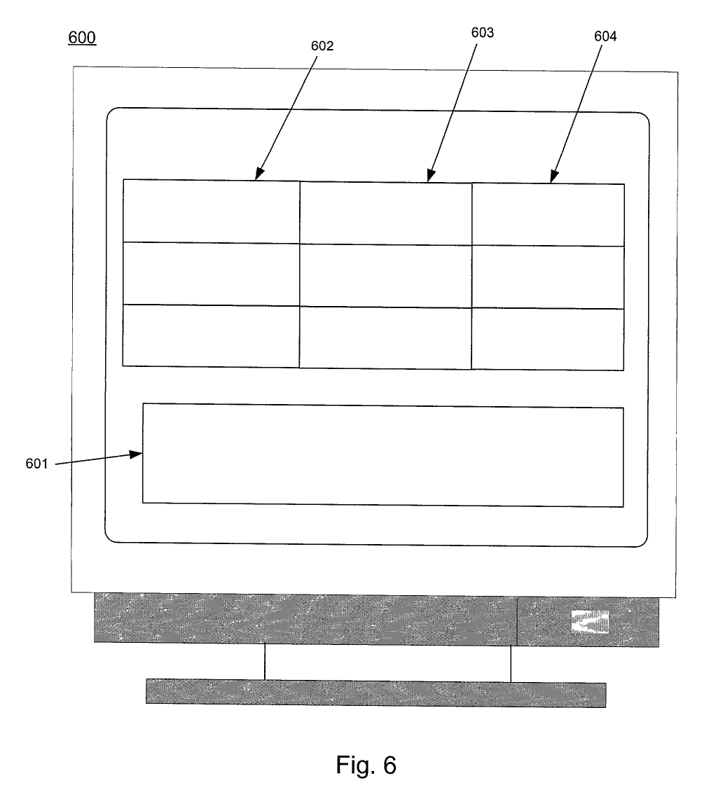

Referring now to FIG. 6, an exemplary GUI 600 for presenting various aspects of embodiments of the present invention on a display 210 is illustrated. The GUI 600 can include geographic areas of a user interface containing interactive areas for entering an event 602; another geographic area 603 can include interactive areas for indicating a notification profile, or specific notification instructions which may be dependent upon a party who is initiating a communication. Still another area of the GUI 604 can include an interactive portion for specifying a party who may initiate a communication that will be associated with a customized notification. Information relating to a location verification mechanism can be displayed in another area of the GUI 601.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. For example, customization of the notification can be accomplished by the PCD 103 at the PCD 103 or by a carrier that provides a communication service to the PCD 103, such as, for example, a cellular telephone signal provider. Notification software can interact with proprietary calendaring and personal information management software to provide the additional inventive functionality, or be embodied in a stand alone software product. Other variations of relating to implementation of the functions described herein can also be implemented. Accordingly, other embodiments are within the scope of the following claims.

What is claimed is:

1. A method for facilitating a wireless communication comprising:
receiving data descriptive of a schedule event, wherein the data comprises a notification profile;
storing the received data descriptive of the schedule event, wherein the data comprises a description of a geographic location and at least one of a) time and b) date;
determining a geographic location;
receiving an indication of an incoming communication;
determining if the determined location relates to a schedule event; and
generating a notification according the received data and at least one of a) geographic location, b) time of a schedule event, c) date of a schedule event and d) party originating the communication.

2. The method of claim 1 wherein the communication comprises a voice call.

3. The method of claim 1 wherein the notification generated comprises a ring with an adjustment to one or more of a) ring volume b) ring tone and c) ring pattern.

4. The method of claim 1 wherein the notification generated comprises a vibration.

5. The method of claim 1 wherein the notification generated comprises visual indication.

6. The method of claim 1 wherein the notification generated comprises withholding any indication of notification.

7. The method of claim 1 wherein the means for determining a geographic location comprises global positioning satellite signal.

8. The method of claim 1 wherein the means for determining a geographic location comprises a calculation utilizing data derived from an enhanced observed time difference/time of arrival signal.

9. The method of claim 1 wherein the data descriptive of a schedule event is received from a personal information manager.

10. A system for facilitating a wireless communication comprising:
a means for receiving data descriptive of a schedule event, wherein the data comprises a notification profile;
a means for storing the received data descriptive of the schedule event, wherein the data comprises a description of a geographic location and at least one of a) time and b) date;
a means for determining a geographic location;
a means for receiving an indication of an incoming communication;
a means for determining if the determined location relates to a schedule event; and
a means for generating a notification according the received data and at least one of a) geographic location, b) time of a schedule event, c) date of a schedule event and d) party originating the communication.

11. The system of claim 11 wherein the communication comprises a voice call.

12. The system of claim 11 wherein the communication comprises an alphanumeric text message.

13. The system of claim 11 wherein the notification generated comprises a ring with an adjustment to one or more of a) ring volume b) ring tone and c) ring pattern.

14. The system of claim 11 wherein the notification generated comprises a vibration.

15. The system of claim 11 wherein the notification generated comprises visual indication.

16. The system of claim 11 wherein the notification generated comprises withholding any indication of notification.

17. The system of claim 11 wherein the means for determining a geographic location comprises global positioning satellite signal.

18. The system of claim 11 wherein the means for determining a geographic location comprises a calculation utilizing data derived from an enhanced observed time difference/time of arrival signal.

19. The system of claim 11 wherein the data descriptive of a schedule event is received from a personal information manager.

20. Computer executable program code residing on a computer-readable medium, the program code comprising instructions for causing a computerized device to:
receive data descriptive of a schedule event, wherein the data comprises a notification profile;
store the received data descriptive of the schedule event;
determine a geographic location;
receive an indication of an incoming communication;
determine if the determined location relates to a schedule event; and
generate a notification according the received data and at least one of a) geographic location, b) time of a schedule event, c) date of a schedule event and d) party originating the communication.

21. The computer executable program code of claim 18 wherein the computerized device comprises a personal communication device.

22. The computer executable program code of claim 18 wherein the geographic location is determined via information comprising a global positioning satellite signal.
